(19) United States
(12) Patent Application Publication
(10) Pub. No.: US 2002/0198779 A1
(43) Pub. Date: Dec. 26, 2002

(54) System and method for awarding participants in a marketing plan

(76) Inventors: Michael Rowen, Oakton, VA (US); Nicole Lewis, Washington, DC (US)

Correspondence Address: BAKER & MCKENZIE, 805 THIRD AVENUE, NEW YORK, NY, 10022, US

(21) Appl. No.: 10/166,454

(22) Filed: Jun. 10, 2002

Related U.S. Application Data
(60) Provisional application No. 60/300,391, filed on Jun. 22, 2001.

(51) Int. Cl. G06F 17/60

(52) U.S. Cl. 705/14

(57) ABSTRACT

A system and method for using a multi-level marketing plan to market financial instruments such as a credit card, a loan or credit line, and for determining participant awards in the plan in a unique manner are provided. The activity data of the financial instruments issued to a primary participant and its downstream participants are received from a customer transaction database. The activities data received typically cover one billing cycle and may include such items as purchases, cash advances. Based on the received activities data, a primary award attributable to activities of the primary participant is determined and downstream award attributable to activities of the downstream participants of the primary participant is determined. The two awards are added and the total award is provided to the primary participant. In another aspect, participant awards are provided by person-to-person (P2P) payment method. For example, the participants who are eligible for awards may be given payments directly into their financial instruments.

### CROSS-REFERENCE TO RELATED APPLICATIONS

This application claims benefit of the Provisional Application No. 60/300,391 filed Jun. 22, 2001.

### TECHNICAL FIELD

The present invention is related to data processing systems, and in particular, to a system and method for determining awards to participants in a marketing plan.

### BACKGROUND OF THE INVENTION

A financial products industry such as the credit card industry has become increasingly competitive as the number of card issuers has grown substantially over the years. Issuers compete fiercely for new customers. As a result, millions of dollars are spent in marketing and advertising.

One effective method of marketing has traditionally been mass mailing of credit card offers to potential consumers. It's relatively cheap and the response rate was very favorable. However, as consumers were bombarded with ever increasing number of credit card offers while the credit market was being saturated, the offers were often thrown away. The consequential decrease in the response rate has substantially increased the cost of acquiring new customers this way.

With recent rapid development of the Internet, card issuers also turned to Internet advertising to sign up new customers. Unfortunately, the click through rate, that is the percentage of users who click on the displayed advertisement, was substantially lower than anticipated. Moreover, when potential customers attempt to apply for the card online upon clicking through the advertisement, they often abandon their efforts in the middle of filling out an online form.

Therefore, there is a need for a more effective system and method for marketing financial instruments.

### SUMMARY OF THE INVENTION

There is provided a system and method for using a multi-level marketing plan to market financial instruments such as a credit card, a loan or credit line, and for determining participant awards in the plan in a unique manner.

The activity data of the financial instruments issued to a primary participant and its downstream participants are received from a customer transaction database. The activities data received typically cover one billing cycle and may include such items as purchases, cash advances. Based on the received activities data, a primary award attributable to activities of the primary participant is determined and downstream award attributable to activities of the downstream participants of the primary participant is determined. The two awards are added and the total award is provided to the primary participant.

In another aspect, participant awards are provided by person-to-person (P2P) payment method. For example, the participants who are eligible for awards may be given payments directly into their financial instruments. Unlike the known P2P services such the PayPal, Bill Point, and C2It, which requires separate accounts to be set up to send or receive payments, the present method and system provides participant awards directly into the participant's financial instruments. For example, a primary participant who holds a credit card from one financial institution who markets a credit card from the same financial institution to a friend may receive a credit on his credit card as an award payment from that financial institution. In addition, each time additional credit cards are marketed or used downstream, the participants may receive P2P payments directly into their credit cards as awards. Yet another form of an award may include a free use of the P2P service for the participants.

### BRIEF DESCRIPTION OF THE DRAWINGS

FIG. 1 is a block diagram of an award determination system according to the present invention.

FIG. 2 is a diagram illustrating an exemplary method for rewarding a participant in a 7-level marketing plan.

FIG. 3 is a flow diagram of an award determination routine.

FIG. 4 is a flow diagram of determining the primary and downstream awards based on activities of the primary and downstream participants.

FIGS. 5A through 5C are examples of determining the award for the primary participant under various scenarios.

### DETAILED DESCRIPTION OF THE INVENTION

Generally, as described in U.S. Pat. No. 6,134,533 issued Oct. 17, 2000, and in U.S. Pat. No. 5,537,314 issued Jul. 16, 1996, multi-level marketing is a technique used by merchants to aid the sale of their products. A merchant typically uses participants. These participants (primary participants) solicit other participants (downstream participants) who aid in selling the merchant's products. The primary participants can buy products from the merchant and use the products themselves or sell the products to others. Each primary participant can also solicit downstream participants who inherit the same opportunities as the person soliciting them has. This means the downstream participants can also purchase, use or sell the merchant's products and solicit other further downstream participants.

With multi-level marketing, a primary participant earns money in two ways. One way is for the primary participant himself to buy products from the merchant and sell them to others at a markup. The other way is for the primary participant to receive a commission on his downstream participants' sales. When a sale is made by the downstream participant who has been directly solicited by the primary participant, the primary participant receives a commission. In that case, the commission structure is considered to have gone through one level of sponsorship. Commissions can be derived from more than one level of sponsorship, such as when a second level downstream participant solicited by the primary participant's first level downstream participant makes a sale. According to that structure, the primary participant might earn a commission from that sale, which is considered to have gone through two levels of sponsorship. In sum, the traditional multi-level marketing method provides awards based on sale of products by the participants and their downstream participants.

By contrast, the compensation method of the present invention is based on use or activities of financial products sold by the participants. According to the principles of the present invention, compensation is given to a primary participant when the primary participant or any of the downstream participants use or have activities on their financial products. In marketing credit cards as the financial product, for example, the primary participant is compensated whenever his or her card is used to make a purchase or used to take out a cash advance. The primary participant is also compensated whenever any of the downstream participants simply uses his or her card. In other words, once the cards have been marketed and issued to participants, there is no more active marketing to be done since the primary participant is awarded whenever the cards issued to his or her downstream participants are used.

For purposes of clarity, the present invention will be described with reference to multi-level marketing of credit cards. However, persons of ordinary skill in the art will appreciate that the techniques described herein may be used in marketing of any other financial instruments such as credit lines, debit cards, loans, deposits such as CDs' and money market, stored value cards, mutual fund accounts, or the like. In the case of a loan instrument, an award can be earned based on activities on the loan such as when payments are made. In the case of a credit line, the award can be earned when there is activity such as when the borrower/participant borrows or draws down money against the credit line.

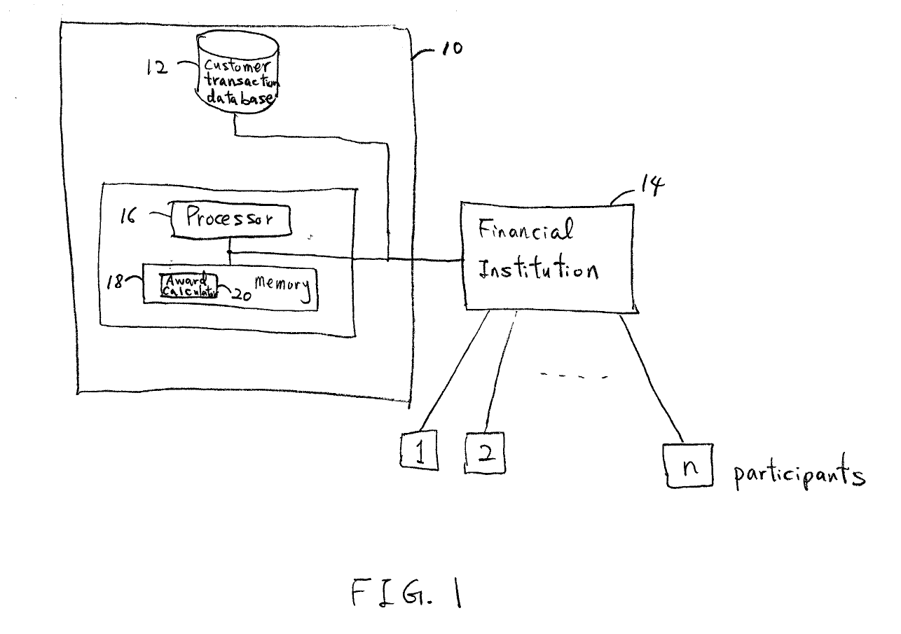

The present invention is implemented in an award determination system 10 as illustrated in FIG. 1. A financial institution 14 issues financial instruments such as credit cards to all participants (1−n) who are eligible to receive the cards. The financial institution 14 maintains the award determination system 10 that determines awards of all participants (1−n). The system 10 includes a customer transaction database 12 that stores data concerning all transactions or activities of the participants and their payments on the credit cards. The system 10 farther includes a processor 16 and memory 18 connected to each other and to the database 12. The memory 18 stores an award calculator program 20 that is executable by the processor 14. The program 20 determines awards to be provided to the participants (1−n) of the multi-level marketing of credit cards as will be explained in detail below.

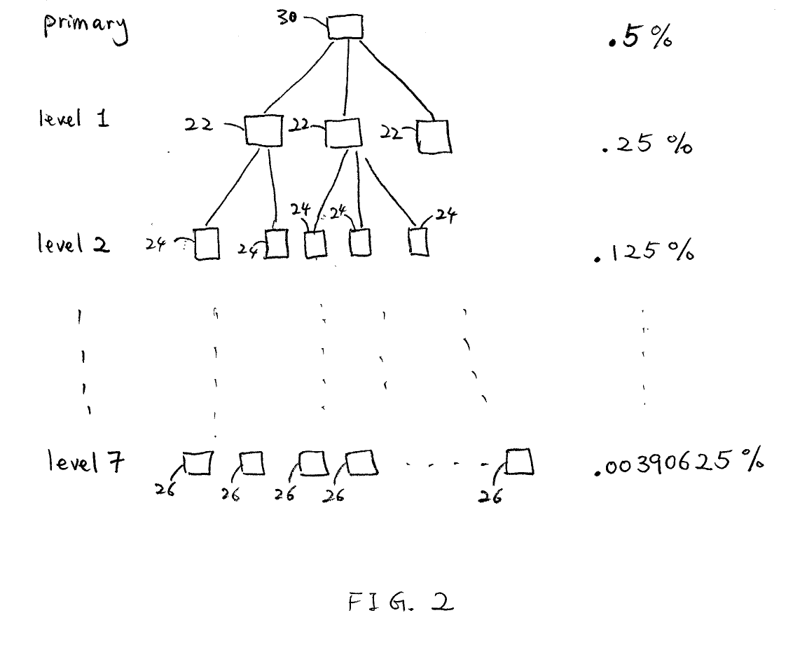

FIG. 2 is a diagram illustrating an exemplary method for rewarding a participant in a 7-level marketing plan. Participants in the multi-level marketing plan include a primary participant 30 and downstream participants 22-26. As a prerequisite, the participants have all applied for and been approved to receive the credit cards issued by the financial institution 14. The downstream participants 22 are level one participants of the primary participant 30 and are directly solicited by the primary participant. The downstream participants 24 are level two participants of the primary participant 30 and are directly solicited by the level one downstream participant 22 and indirectly solicited by the primary participant 30. Similarly, the downstream participants 26 are level seven participants of the primary participant 30 and are directly solicited by level six participants (not shown) and indirectly solicited by the primary participant 30 and participants 22-24. Although not shown, the primary participant 30 may be a downstream participant of a different primary participant at a higher level.

As shown in FIG. 2, the primary participant 30 is awarded for his own use or activities of the credit card. In the embodiment shown, the participant 30 is given a cash back of 0.5% of all purchases, including cash advances, made on the card. In addition, the primary participant 30 is awarded for use of the credit cards by the downstream participants 22-26. The cash back award to the primary participant 30 is reduced by 50% from one level to a successive lower level. For example, the primary participant 30 receives from the financial institution 12 a cash back of 0.25% of all purchases made by the level one downstream participants 22, and 0.125% of all purchases made by the level two downstream participants 24, and so on. While the award given is in the form of cash in FIG. 2, it can be in many different forms including airline miles, reward points which can be redeemed for various products and services, discounts on products or services such as lower rates on automobile finance, contributions to profit or non-profit organizations, changes in terms of product basis such as lower interest rate, lower fees or higher credit lines, or the like.

Assume that a participant spends an average of $300 per month and there are 10 levels in the multi-level marketing plan. If an average participant solicits or recruits 2 additional participants (downstream participants), then there are 2,047 participants in the network for the top level or primary participant. In that case, the primary participant makes $17 per month. As another example, if an average participant solicits 2.5 additional participants (downstream participants), there are 15,894 downstream participants and the primary participant makes $64 per month. As yet another example, if an average participant solicits 3 additional participants (downstream participants), there are 88,573 downstream participants and the primary participant makes $256 per month. As can be appreciated, such a compensation plan provides powerful incentives for the participants to market the credit cards.

From the financial institution's point of view, the compensation plan for multi-level marketing according to the present invention is also compelling. Once the initial marketing phase is completed, acquisition cost for each credit card through the plan is virtually zero. The commission payout to all participants for a given purchase can be limited to no more than 1% which means that the payout can be fully funded by the interchange fee received by the institution.

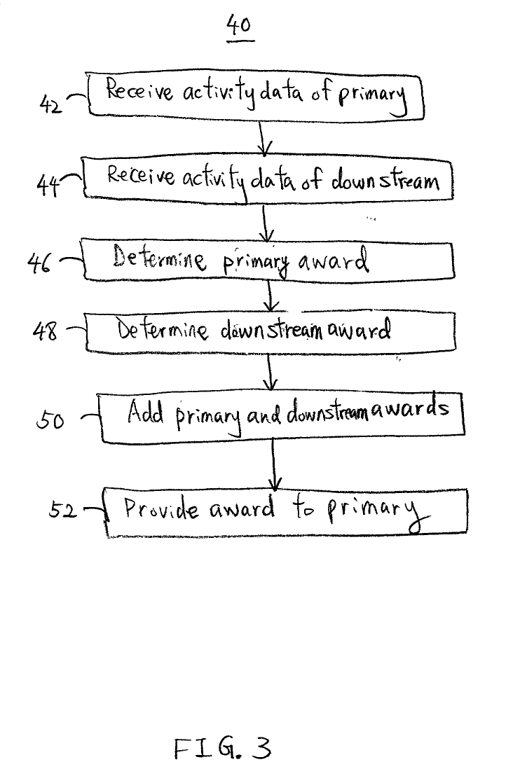

FIG. 3 illustrates a flow diagram of an award determination routine 40 which is a part of the award calculator 20 stored in the memory 18. In step 42, the routine 40 receives from the database 12 activity data of a credit card issued by the financial institution 14 to the primary participant 30 during a billing cycle. The activity data are transaction data which may include, among others, such items as the amount of purchase, amount of cash advance, amount of charge backs, number of days the card is delinquent, number of purchases or cash advances made, and whether the card is closed. The account can be closed for many different reasons including voluntary closure, charge-off by the financial institution 14, or the like. In step 44, the routine 40 receives from the database 12 the activity data during a billing cycle of credit cards issued by the financial institution 14 to respective downstream participants.

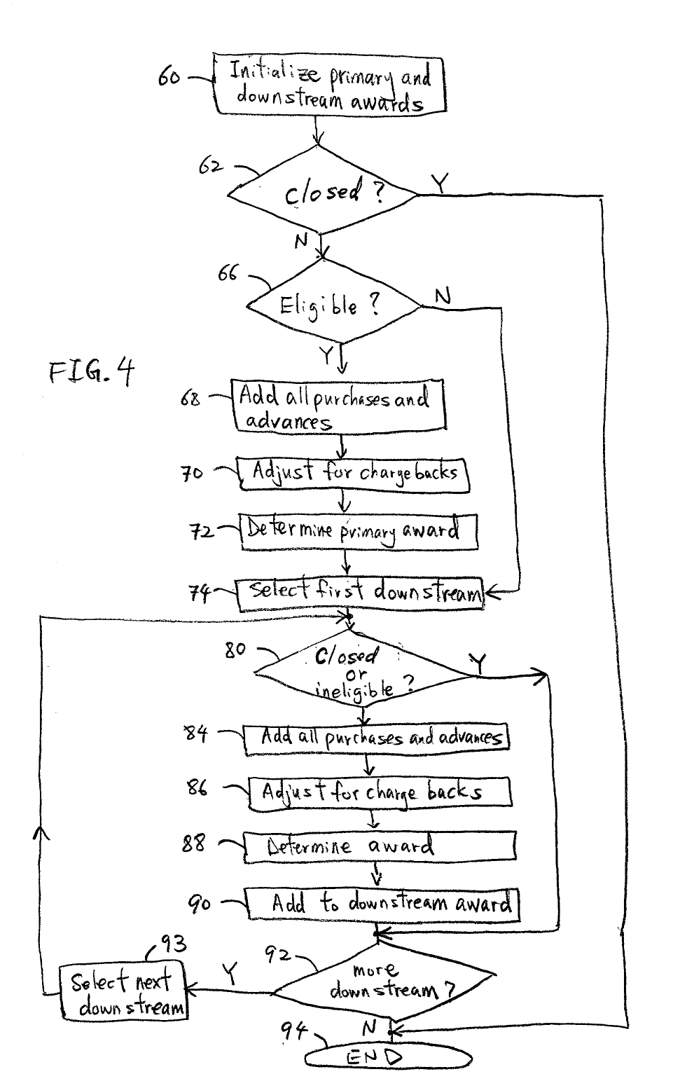

In step 46, an award based on the activity data of the primary participant is determined as a primary award. A detailed method of determining the primary award is described below with reference to FIG. 4. In step 48, an award based on the activity data of the downstream participants is determined as a downstream award. A detailed method of determining the downstream award is explained below with reference to FIG. 4. In step 50, the primary and downstream awards are added to determine the total award due to the primary participant. The total award is then provided to the primary participant 30 in step 52. The award can be provided by lowered card rate, credited in the primary participant's credit card, sent by mail as a check or gift certificates, sent as electronic cash such as Ewallet, credited by ACH (automated clearing house), credited into the participant's checking or savings account, emailed using a service such as paypal.com, or the like. The award can also be savings bonds or stocks in a company such as the financial institution's own stock.

In another aspect, participant awards may be provided by person-to-person (P2P) payment method. P2P transactions refer to electronic transactions that allow one person to exchange money with another person. Typically, an account is set up specifying an account that a person wants to draw money out of and let money flow into. Sending money, for example, by e-mail, debits the account; receiving money credits the account. In the present method and system, for example, the participants who are eligible for awards may be given payments directly into their financial instruments. Unlike the known P2P services such as the PayPal, BillPoint, and C2It, which require separate accounts to be set up to send or receive payments, the present method and system provides participant awards directly into the participant's financial instruments. For example, a primary participant who holds a credit card from one financial institution who markets a credit card from the same financial institution to a friend may receive a credit on his credit card as an award payment from that financial institution. In this way, there is no need to set up a separate service account such as in PayPal. In addition, each time additional credit cards are marketed or used downstream, the participants may receive P2P payments directly into their credit cards as awards. Yet another form of an award may include a free use of the P2P service for the participants.

FIG. 4 illustrates a routine of determining the primary and downstream awards due to the primary participant 30 based on activities of the primary and downstream participants. Step 60 initializes both the primary award and downstream award variables to zero. Step 62 determines whether the credit card of the primary participant has been closed. If it has, control passes to step 94 where the routine ends. In other words, if the primary participant's card has been closed, that participant does not receive any award. If the card has not been closed, control passes to step 66 where it is determined whether the primary participant is eligible. The eligibility criteria may include such variables as a minimum number of purchases per billing cycle and minimum number of days the card is delinquent. One example may be that the primary participant must make a minimum of one purchase per billing cycle and the card is less than 10 days delinquent. If the primary participant is determined not to be eligible, then he does not receive any primary award although he may qualify for the downstream award. Accordingly, control passes to step 74 where the downstream award is determined.

If the primary participant is determined to be eligible, the routine continues with step 68 where all purchase amounts and cash advances are added. In one embodiment, other activities that may influence the award being calculated include such factors as balance transfers, number of approved credit cards issued to participants, interest paid on balance, average balance, fees paid, timely or untimely payments, length of relationship and quality of relationship, profitability of the participant, whether the participant has multiple credit cards from the institution 14.

In step 70, the added amount is adjusted for any charge backs on the card. In step 72, the primary award is then determined based on the adjusted amount. If the commission schedule of FIG. 2 is applied, then the primary award is 0.5% of the adjusted amount.

In step 74, a first downstream participant is selected for purposes of determining that participant's contribution of award to the primary participant 30. Steps 80 through 92 are repeated for each selected downstream participant starting with the first participant. In step 80, it is determined whether the credit card of the selected downstream participant has been closed or is ineligible. The eligibility criteria may be similar to those used for step 66. If it has been closed or is ineligible, then control passes to step 92 where it is determined whether there are any more downstream participants. If yes, the next downstream participant is selected in step 93 and steps 80 through 90 are repeated.

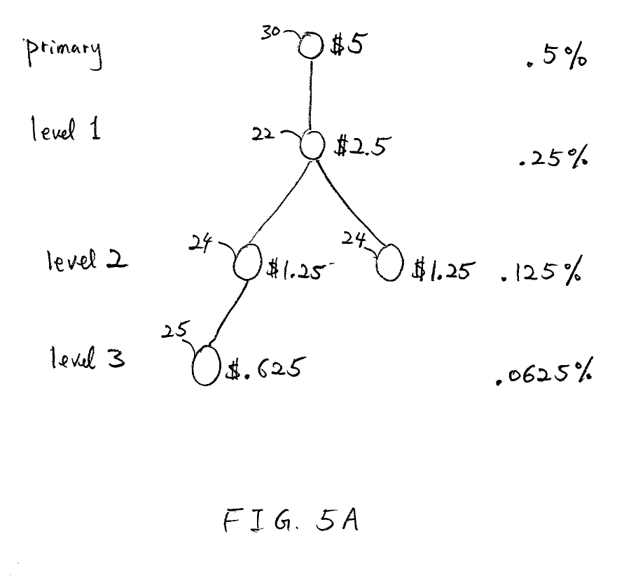

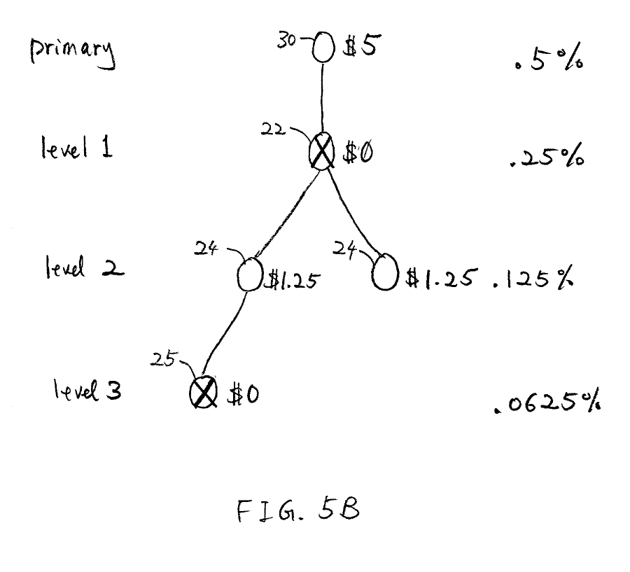

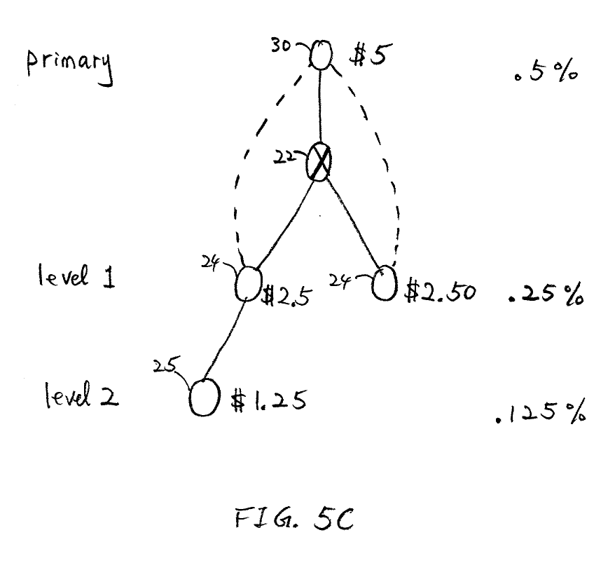

In an alternative embodiment the levels of the downstream participants are “compressed” upward by one level to skip over the closed account 22. For example, if a level one participant's account 22 becomes closed, then previously level two downstream participants 24 now become level one with respect to the primary participant 30 and previously level three downstream participant 25 now becomes level two and so on. In another alternative embodiment, the levels of the downstream participants are “compressed” upward by one level to skip over either the ineligible account or the closed account 22. The compression concept will be explained in detail with reference to FIG. 5C later herein.

If the card has not been closed and it is eligible, then the routine continues with step 84 where all purchase amounts and cash advances made by the selected downstream participant are added. In step 86, the added amount is adjusted for any charge backs on the card. In step 88, the award contributed by the selected downstream participant is then determined based on the adjusted amount. If the commission schedule of FIG. 2 is applied and the selected downstream participant is at level 2, then the contributed award is 0.125% of the adjusted amount. In step 90 the contributed award just determined in step 88 is added to the downstream award. In step 92, it is determined whether there are more downstream participants. If yes, then step 93 selects the next downstream participant and control passes to step 80 to determine that selected participant's award contribution to the primary participant 30. If there are no more downstream participants, then the routine ends in step 94.

FIGS. 5A through 5C provide examples of determining the award for the primary participant in which it is assumed that each participant purchases $1,000 on the card, there are no charge backs and commission schedule of FIG. 2 is used. In FIG. 5A, the primary award is $5 which is 0.5% of $1,000. The downstream award is $5.625 which is determined by adding individual award contributions of the downstream participants: $2.5, $1.25, $1.25, and $0.625. Thus, the total award for the primary participant is $10.625.

Referring now to FIG. 5B, the assumptions made are similar to those of FIG. 5A except that the credit cards of the downstream participants at level one and three are either closed or are not eligible. According to the routine of FIG. 4, award contributions of other eligible downstream participants to the primary participant 30 are not affected. Thus, the downstream award of $2.50 is added to the primary award of $5 for a total award of $7.50 for the primary participant 30.

Referring to FIG. 5C, the assumptions made are similar to those of FIG. 5A except that the credit card of the downstream participant 22 are either closed or are not eligible. As discussed above, in an alternative embodiment the levels of the downstream participants may be compressed upward by one level as shown by the dotted lines to skip over the ineligible or closed account 22 such that formerly level two participants 24 are now at level one with respect to the primary participant 30 and formerly level three participant 25 is now at level two. Thus, the downstream award of $6.25, instead of $3.125 under the routine of FIG. 4 without compression, is added to the primary award of $5 for a total award of $11.25 for the primary participant 30.

From the foregoing, it will be appreciated that, although specific embodiments of the invention have been described herein for purposes of illustration, various modifications may be made without deviating from the spirit and scope of the invention. Accordingly, the present invention is not limited except as by the appended claims.

What is claimed is:

1. A method of determining a participant award in a multi-level marketing plan that markets financial instruments, the method comprising:
receiving activity data of a financial instrument issued to a selected participant;
receiving activity data of financial instruments issued to respective downstream participants of the selected participant;
determining a primary award due to the selected participant based on the received activity data for the selected participant;
determining a downstream award due to the selected participant based on the received activity data for the downstream participants of the selected participant; and
adding the primary and downstream awards to determine the award due to the selected participant.

2. The method according to claim 1 wherein the step of determining a downstream award includes:
repeating the following steps for each downstream participant of the selected participant:
determining a first award due to the selected participant based on the received activity data for the each participant and the level of the each participant in relation to the selected participant; and
adding the first award to the downstream award.

3. The method according to claim 1, further comprising:
determining whether the financial instrument of the selected participant is delinquent; and
reducing the primary award due to the selected participant if the financial instrument of the selected participant is determined to be delinquent.

4. The method according to claim 1, further comprising:
determining whether the financial instrument of at least one of the downstream participants of the selected participant is delinquent;
reducing the downstream award due to the selected participant if the financial instrument of the at least one downstream participant is determined to be delinquent.

5. The method according to claim 1, further comprising:
determining whether the financial instrument of the selected participant is closed; and
if the financial instrument of the selected participant is determined to be closed, the primary award is determined to be zero and the downstream award is determined to be zero.

6. The method according to claim 1, further comprising:
determining whether the financial instrument of the selected participant is eligible for the second award; and
if the financial instrument of the selected participant is determined to be ineligible, the primary award is determined to be zero.

7. The method according to claim 1 wherein the instrument is determined to be eligible if usage of the instrument of the selected participant exceeds a minimum threshold.

8. The method according to claim 1 wherein the step of determining a downstream award includes:
for each downstream participant of the selected participant, multiplying a usage amount of the financial instrument of the each downstream participant by a predetermined factor, the predetermined factor at one level that is further away from the selected participant being smaller than the predetermined factor at another level that is closer to the selected participant.

9. The method according to claim 8 wherein the predetermined factor at a selected level is determined by multiplying a constant factor by the predetermined factor at a preceding level that is one level higher than the selected level, the constant factor being in a range of zero to one.

10. The method according to claim 1, further comprising:
receiving an application for the financial instrument from a downstream participant of the selected participant;
determining whether to approve the application; and
providing a separate award to the selected participant upon approval of the financial instrument application from the downstream participant of the selected participant.

11. The method according to claim 1 wherein the financial instruments are credit cards and the activity data include purchases made by the selected participant and the downstream participants using the respective credit cards.

12. The method according to claim 1 wherein the financial instruments are loans and the activity data include payments on the loans by the selected participant and the downstream participants.

13. The method according to claim 1 wherein the financial instruments are deposit accounts and the activity data include deposits made to the deposit accounts by the selected participant and the downstream participants.

14. The method according to claim 1 wherein the financial instruments are debit accounts, charge accounts, or stored value cards.

15. A method of awarding participants in a multi-level marketing plan that markets financial instruments, the method comprising:
opening an account of a financial instrument to each participant;
receiving activity data of the accounts;
for each primary participant,
determining an award for each primary participant based on the received activity data of the each primary participant and based on the received activity data of downstream participant of the each primary participant.

16. The method of claim 15, further including:
crediting an amount of the award to a financial instrument of each primary participant.

17. The method of claim 15, further including:
allowing the each primary participant to freely use person-to-person (P2P) service associated with a financial instrument of the each primary participant.

18. A method of claim 1, further including:
crediting an amount of the award to a financial instrument of the selected participant.

19. A method of awarding participants in a marketing plan that markets financial instruments, comprising:
opening an account of a financial instrument to each participant;
receiving activity data of the accounts;
for each participant who marketed at least one financial instrument,
determining an award amount based on at least one of the received activity data of the accounts;
crediting the award amount to a financial instrument of the each participant who marketed at least one financial instrument.
